(19) United States
(12) Patent Application Publication
(10) Pub. No.: US 2006/0289505 A1
(43) Pub. Date: Dec. 28, 2006

(54) Information processing apparatus and fan control method

(75) Inventor: Shinsuke Yato, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/443,288

(22) Filed: May 31, 2006

(30) Foreign Application Priority Data
May 31, 2005 (JP) 2005-159641

(51) Int. Cl. H05B 6/50

(52) U.S. Cl. 219/704

(57) ABSTRACT

According to one embodiment, an information processing apparatus includes a fan which rotates from a stopping state upon supplying a voltage not less than a predetermined voltage value, a first detector which outputs a signal indicating whether the fan is rotating or not, a storage which stores voltage information indicating a voltage value supplied to the fan, a power supply which supplies a voltage corresponding to the voltage information stored in the storage to the fan, a second detector which detects a lowest rotation voltage value with which the fan rotates, and a setting section which sets the voltage information corresponding to the lowest rotation voltage value detected by the second detection section to the storage section.

### CROSS-REFERENCE TO RELATED APPLICATIONS

This application is based upon and claims the benefit of priority from Japanese Patent Application No. 2005-159641, filed May 31, 2005, the entire contents of which are incorporated herein by reference.

### BACKGROUND

1. Field

One embodiment of the invention relates to an information processing apparatus provided with a cooling fan and a fan control method.

2. Description of the Related Art

In recent years, heat generation of electronic parts mounted on a notebook type personal computer becomes large, and thus the products in which a cooling fan is mounted on the electronic parts are increasing.

When the electronic parts are driven actually, cooling is carried out in such a way as to rotate the cooling fan with the number of rotations depending on temperature of the electronic parts. In the case where the electronic parts are in an idling state, it is preferable that the number of rotations of the cooling fan is made as low as possible, in order to suppress the whizzing noise caused by the cooling fan.

Jpn. Pat. Appln. KOKAI Publication No. 2000-333487 has disclosed a technique in which the voltage supplied to the cooling fan is made to change in order to rotate the cooling fan at minimum rotational speed set beforehand so that the number of rotations of the cooling fan is made as low as possible.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an exterior of an information processing apparatus according to an embodiment of the present invention;

FIG. 2 is an exemplary block diagram showing an example of a system configuration of the information processing apparatus of FIG. 1;

FIG. 3 is an exemplary block diagram showing a system configuration to control the number of rotations of a fan provided on the information processing apparatus of FIG. 1;

FIG. 4 is an exemplary view showing a relationship between measurement temperature and the number of rotations of the fan provided within a BIOS-ROM;

FIG. 5 is an exemplary view showing rotational characteristics of the cooling fan;

FIG. 6 is an exemplary flowchart showing procedures of a fan control method according to an embodiment of the present invention; and

FIG. 7 is an exemplary flowchart showing procedures of a fan control method according to an embodiment of the present invention.

### DETAILED DESCRIPTION

Various embodiments according to the invention will be described hereinafter with reference to the accompanying drawings. In general, according to one embodiment of the invention, an information processing apparatus comprises a cooling fan which rotates from a stopping state upon supplying a voltage not less than a predetermined voltage value, a first detection section which outputs a signal indicating whether the fan is rotating or not, a storage section which stores voltage specification information indicating a voltage value supplied to the cooling fan, a power supply which supplies a voltage corresponding to the voltage specification information stored in the storage section to the cooling fan, a second detection section which detects a lowest rotation voltage value with which the cooling fan rotates, by setting the voltage specification information corresponding to the voltage value obtained by dropping voltage value by a predetermined step voltage value each from the predetermined voltage value, to the storage section while monitoring signals supplied from the first detection section, and a setting section which sets the voltage specification information corresponding to the lowest rotation voltage value detected by the second detection section to the storage section.

Hereinafter, referring to the drawings, there will be described the embodiment of the present invention.

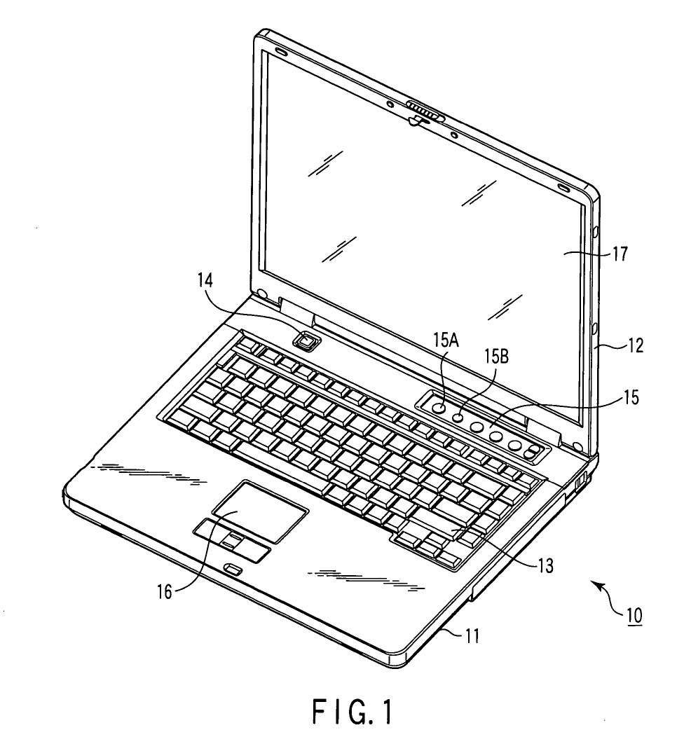

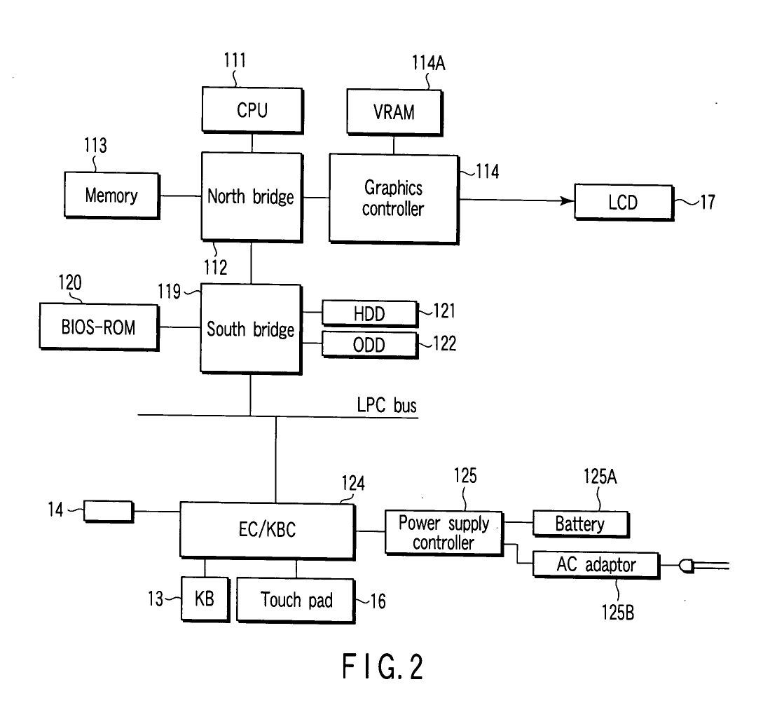

First, there will be described a configuration of the information processing apparatus according to one embodiment of the present invention, referring to FIGS. 1 and 2. The information processing apparatus is realized as a portable type notebook type personal computer 10 capable of being battery driven.

FIG. 1 is a perspective view in a state in which a display unit of the notebook type personal computer 10 is opened. The computer 10 of the present embodiment is composed of a computer main body 11 and a display unit 12. A display device composed of a liquid crystal display (LCD) 17 is installed on the display unit 12; and a display screen of the LCD 17 is located approximately at the center the display unit 12.

The display unit 12 is mounted on the computer main body 11 capable of being rotated freely between an opened position and a closed position. The computer main body 11 has a thin box type housing; and on the upper surface thereof, there are disposed a keyboard 13, a power button 14 for turning ON/OFF of a power supply of the computer 10, an input operation panel 15 and a touch pad 16 and the like.

The input operation panel 15 is an input unit for inputting an event corresponding to a button pressed; and plural buttons are provided to start respective plural functions. These buttons group also include a TV start-up button 15A, a DVD/CD start-up button 15B. The TV start-up button 15A is a button for reproducing TV broadcast program data. When the TV start-up button 15A is pressed down by a user, an application program for reproducing the TV broadcast program data is automatically started. The DVD/CD start-up button 15B is a button for reproducing video contents stored in the DVD or CD. When the DVD/CD start-up button 15B is pressed down by the user, an application program for reproducing video contents is automatically started.

Next, there will be described the system configuration of the computer 10 of the present application referring to FIG. 2.

As shown in FIG. 2, the computer 10 is provided with a CPU 111, a north bridge 112, a main memory 113, a graphics controller 114, a south bridge 119, a BIOS-ROM 120, a hard disk drive (HDD) 121, an optical disk drive (ODD) 122, an embedded controller/keyboard controller IC (FC/KBC) 124 and the like.

The CPU 111 is a processor provided to control operation of the computer 10, and the CPU 111 executes an operating system (OS) and various kinds of application programs loaded to the main memory 113 from the hard disk drive 121. The OS has a window system for displaying plural windows on a display screen.

Further, the CPU 111 also executes a system BIOS (Basic Input Output System) stored in the BIOS-ROM 120. The system BIOS is a program for hardware control.

The north bridge 112 is a bridge device for connecting between a local bus of the CPU 111 and the south bridge 119. A memory controller for accessing and controlling the main memory 113 is also incorporated in the north bridge 112. In addition, the north bridge 112 has also a function for executing communication to the graphics controller 114 via an AGP (Accelerated Graphics Port) bus or the like.

The graphics controller 114 is a display controller for controlling the LCD 17 used as a display monitor of the computer 10. The graphics controller 114 has a video memory (VRAM), and generates video signals for forming a display image to be displayed on the LCD 17 from the display data drawn on the video memory with an OS/application program. The display image to be displayed on the LCD 17, usually, is constituted from a image on the desktop screen and each image of the windows disposed on the desktop screen. However, when displaying the moving image with the full screen mode, the display image to be displayed on the LCD 17 is constituted by only the image of the moving image. Therefore, when displaying the moving image with the full screen mode, the video signal for forming only the display image of the moving image is outputted from the graphics controller 114.

The south bridge 119 controls each device on a LPC (Low Pin Count) bus. In addition, the south bridge 119 contains an IDE (Integrated Drive Electronics) controller for controlling the HDD 121 and ODD 122. Further, the south bridge 119 has a function for controlling the TV tuner 123 and a function for accessing and controlling the BIOS-ROM 120.

The ODD 122 is a drive unit for driving a storage media such as the DVD, CD or the like in which the video contents are stored.

The embedded controller/keyboard controller IC (FC/KBC) 124 is a one chip microcomputer in which an embedded controller for power supply control and heat-dissipation control and a keyboard controller for controlling the keyboard (KB) 13 and the touch pad 16 are integrated. The embedded controller/keyboard controller IC (FC/KBC) 124 has a function for performing power on/power off of the computer 10 of the present embodiment depending on operation of a power button 14 by a user.

Now, semiconductor devices such as the CPU 111, the north bridge 112, the south bridge 119, the graphics controller 114, the HVE 115, the TV tuner 123 and the like have a large heating value, and thus a cooling fan is mounted. Further, even in an idling state, when stopping the fan, temperature inside the computer main body 11 increases. Therefore, it is not preferable to stop the fan. It is preferable to set the number of rotations of the fan as low as possible in the idling state to suppress noise.

There will be described with respect to constitution for controlling the number of rotations of the fan below.

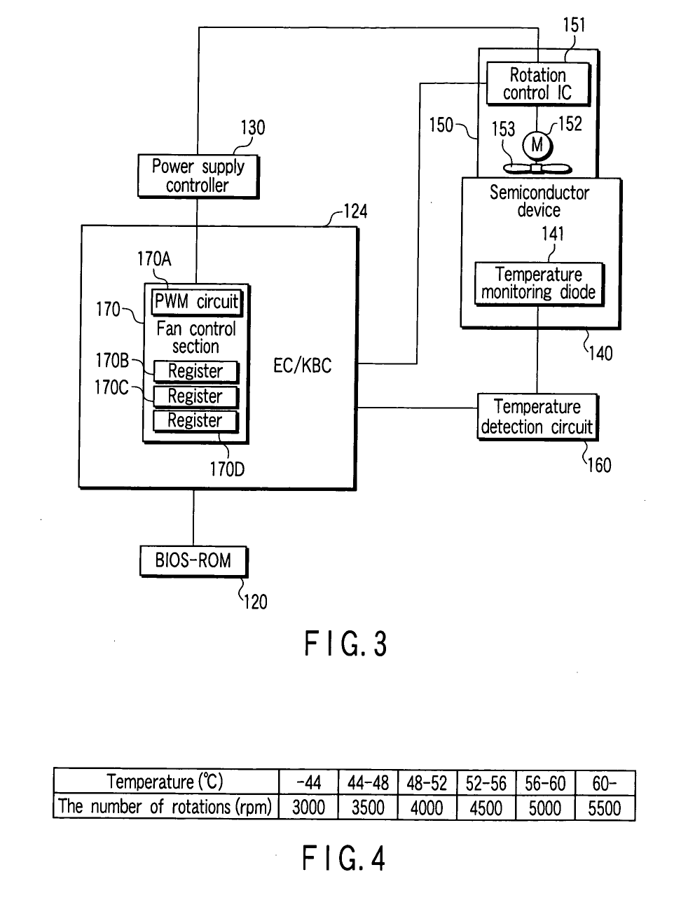

FIG. 3 is a view showing constitution for controlling the number of rotations of the fan according to one embodiment of the present invention.

As shown in FIG. 3, a cooling fan 150 is mounted on a semiconductor device 140. The cooling fan 150 is provided with a rotation control IC 151, a motor 152, and a fan 153. The fan 153 rotates in such a way that a drive voltage supplied from a power supply controller 130 is supplied to the motor via the rotation control IC 151. The number of rotations of the fan 153 is monitored by the rotation control IC 151. The rotation control IC 151 supplies a pulse signal in accordance with the number of rotations of the fan 153 to the EC/KBC 124.

A temperature measuring diode 141 is provided inside the semiconductor device 140. A temperature detection circuit 160 measures forward voltage drop of the temperature measuring diode 141 on the occasion of flowing constant current into the temperature measuring diode 141. Then, the temperature detection circuit 160 obtains the temperature at the position where the temperature measuring diode 141 of the semiconductor 140 is formed based on temperature characteristics of the forward voltage drop of the temperature measuring diode 141. The obtained temperature is supplied to the EC/KBC 124.

The EC/KBC 124 controls drive voltage value supplied to the rotation control IC 151 of the cooling fan 150 from the power supply controller 130 in order to control the number of rotations of the fan 153 of the cooling fan 150 in accordance with the temperature detected by the temperature detection circuit 160.

The number of rotations of the fan 153 depending on the temperature is stored in the BIOS-ROM 120. FIG. 4 shows the number of rotations of the fan 153 with respect to the temperature.

A characteristic formula showing a relationship between the number of rotations and the drive voltage is stored in the EC/KBC 124. The EC/KBC 124 acquires the number of rotations corresponding to the measured temperature from the BIOS-ROM 120, obtains the drive voltage value of the cooling fan 150 from the acquired number of rotation and the characteristic formula, and writes voltage specification information corresponding to the voltage value in a drive voltage value register 170B of a fan control section 170. A PWM circuit 170A in the fan control section 170 generates pulse width modulation (PWM) signal corresponding to the written voltage specification information to supply it to the power supply controller 130. The PWM signal shows a level of drive voltage with a size of pulse width. Additionally, since the level of the drive voltage is shown with the size of the pulse width, in the case where the PWM signal is not outputted, that is, when the signal is “0”, the drive voltage value is zero. The PWM signal specification information indicating the PWM signal corresponding to each voltage obtained by dividing 0 to 5V is set in the BIOS-ROM 120. The PWM circuit 170A reads out the PWM signal specification information corresponding to the voltage specification information written in the drive voltage value register 170B; and supplies the read out PWM signal corresponding to the PWM signal specification information to the power supply controller 130.

Now, since the semiconductor device 140 has considerable heating amount even in an idling state, it is not possible to set the number of rotations of the fan 153 to zero. However, it is sufficient as long as a little wind blows against the semiconductor device 140. Consequently, when taking into consideration of the noise or the like, the number of rotations of the fan 153 should be as low as possible, preferably. It is desired to cause the fan 153 to rotate in an efficient low speed at the idling state. However, since the semiconductor device 140 becomes considerably hot in the operation state, there is a tendency to set the characteristic of the motor 152 in high rotation.

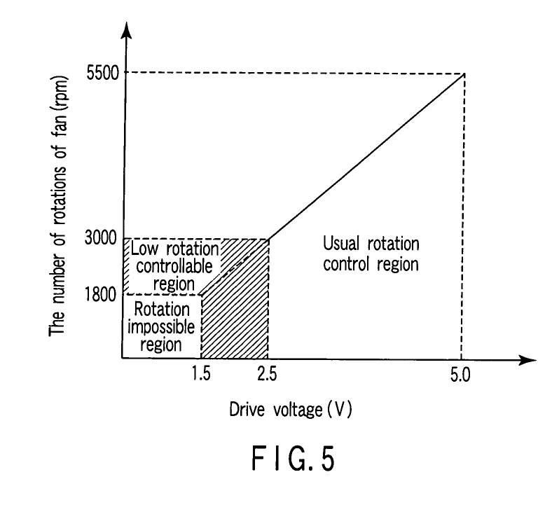

FIG. 5 shows an example of rotation characteristics of the cooling fan 150. As shown in FIG. 5, there is a low rotation controllable region where the fan 153 is capable of rotating between a rotation control region and a rotation impossible region. The drive voltage in the low rotation controllable region is outside the guarantee region of the cooling fan 150. In order to rotate the fan 153 in as low a rotation number as possible, the fan must be rotated at the low rotation controllable region. Hereinafter, there will be described a method for driving the cooling fan at the low rotation controllable region in the number of rotations as low as possible.

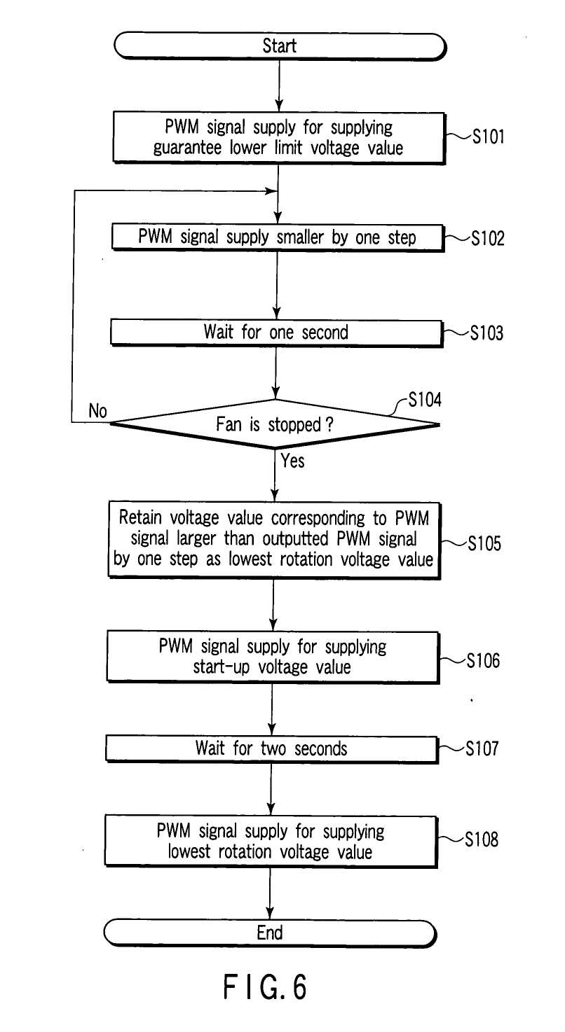

FIG. 6 is a flowchart showing a cooling fan control method according to one embodiment of the present invention. Following processing is executed in the case where the semiconductor device 140 on which the cooling fan 150 is mounted is made the idling state, thus temperature of the semiconductor device is sufficiently low.

First, when the semiconductor device 140 is in the idling state and the temperature of the semiconductor device 140 is low, the BIOS instructs the EC/KBC 124 to set the cooling fan 150 in a lowest rotation state.

The instructed EC/KBC 124 writes voltage specification information corresponding to a guarantee low limit voltage value for the cooling fan 150 in the drive voltage value register 170B, and the PWM circuit 170A supplies the PWM signal corresponding to the guarantee low limit voltage to the power supply controller 130 (block S101). The power supply controller 130 supplies the drive voltage corresponding to the size of the pulse width of the supplied PWM signal, in this case, supplies the guarantee low limit voltage to the cooling fan 150.

Next, processing is performed for obtaining a non-rotation maximum voltage in which the fan 153 stops rotation. The EC/KBC 124 writes the voltage specification information in accordance with a voltage value being smaller than the drive voltage value written in the drive voltage value register 170B by one step, and the PWM circuit 170A supplies the PWM signal corresponding to the written voltage value to the power supply voltage controller 130 (block S102). The voltage value of one step is determined based on an adjacent width of voltage value interval when dividing the voltage of 0 to 5V into 256. However, since it takes time for finding the non-rotation maximum voltage when amount of the step is small, the voltage value of one step employs appropriate value depending on the characteristic of the fan used.

The EC/KBC 124 waits for one second from the time of writing the voltage specification information in the drive voltage value register 170B (block S103).

The EC/KBC 124 judges whether or not the fan 153 is rotating from the pulse signal from the rotation control IC 151 (block S104). Whether or not the fan 153 is rotating is judged based on whether the pulse signal supplied to the EC/KBC 124 from the rotation control IC 151 is outputted (rotation state) or is not outputted (stop state). At this time, the number of rotations of the fan 153 is not given as a target value because when the drive voltage supplied to the cooling fan 150 decreases than a certain degree, a circuit for generating the pulse signal in the rotation control IC 151 does not operate appropriately, and it is conceivable to be seen as if the fan had rotated in a high speed. Thus, the non-rotation maximum voltage is judged from the rotation state or the stop state.

Although the voltage is one in which the fan 153 does not rotate, the fan 153 rotates for a moment with inertia. In order to certainly judge the voltage which is a voltage in which the fan 153 rotates reliably, a new PWM signal is supplied to the power supply controller 130, and then existence of the rotation of the fan 153 is judged after one second of elapsed time.

When the fan 153 is not stopped (No in block S104), the EC/KBC 124 sequentially performs blocks S102 to S104 until the fan 153 is stopped.

When the fan 153 is stopped (Yes in block S104), EC/KBC 124 writes the voltage specification information corresponding to one-step higher voltage value than the voltage value corresponding to the voltage specification information written in the drive voltage value register 170B in a lowest rotation voltage value register 170C (block S105).

The EC/KBC 124 writes the voltage specification information depending on a start-up voltage value of the fan in the drive voltage value register 170B to rotate the fan 153 in the stop state, and the PWM circuit 170A supplies the PWM signal corresponding to newly written voltage specification information to the power supply controller 130 (block S106). The new PWM signal is supplied to the power supply controller 130, thereby the voltage by which the fan 153 in the stop state is capable of rotating is supplied to the cooling fan 150. In some cases, in order to rotate the fan 153 in the stop state, larger torque becomes necessary than the torque which is generated by the motor 152 with the guarantee low limit voltage. Consequently, for instance, an intermediate value between the guarantee lower limit voltage and the guarantee upper limit voltage is used as the start-up voltage.

The EC/KBC 124 waits for 2 seconds, after setting the voltage specification information in accordance with the start-up voltage as an output value of the PWM signal (block S107). After standby, the EC/KBC 124 writes the voltage specification information written in the lowest rotation voltage value register 170C in the drive voltage value register 170B, and the PWM circuit 170A supplies the PWM signal corresponding to the written voltage specification information to the power supply controller 130 (block S108). The power supply controller 130 supplies the lowest rotation voltage to the cooling fan 150, thereby the fan 153 rotates in a low speed rotation.

By the processing described above, it is possible to drive the cooling fan 150 with the voltage immediately before the state where the fan 153 is stopped. In this state, since the number of rotations of the fan 153 is the smallest, it is possible to make the sound emitted from the cooling fan 150 small. By always making the fan operate in a low rotation, it is possible to prevent the semiconductor device 140 from sharply rising in temperature. Further, by always making the fan operate in a low rotation, it is possible to reduce temporary noise occurrence at the time of the fan start-up.

This lowest number of rotation operation is set as a different mode from the usual number of rotation control operation. When the lowest rotation operation is required initially after the system start-up time, performing a detection operation first, after which the lowest number of rotation retaining operation is performed. Further, when the system is set to OFF state once, the lowest rotation voltage being retained at that time is cancelled once (since it is conceivable that disturbances or the like caused by environmental change such as temperature, use method or the like takes place). In addition, also when abnormal state occurs during the lowest number of rotation retaining operation, the lowest rotation voltage retained is cancelled once.

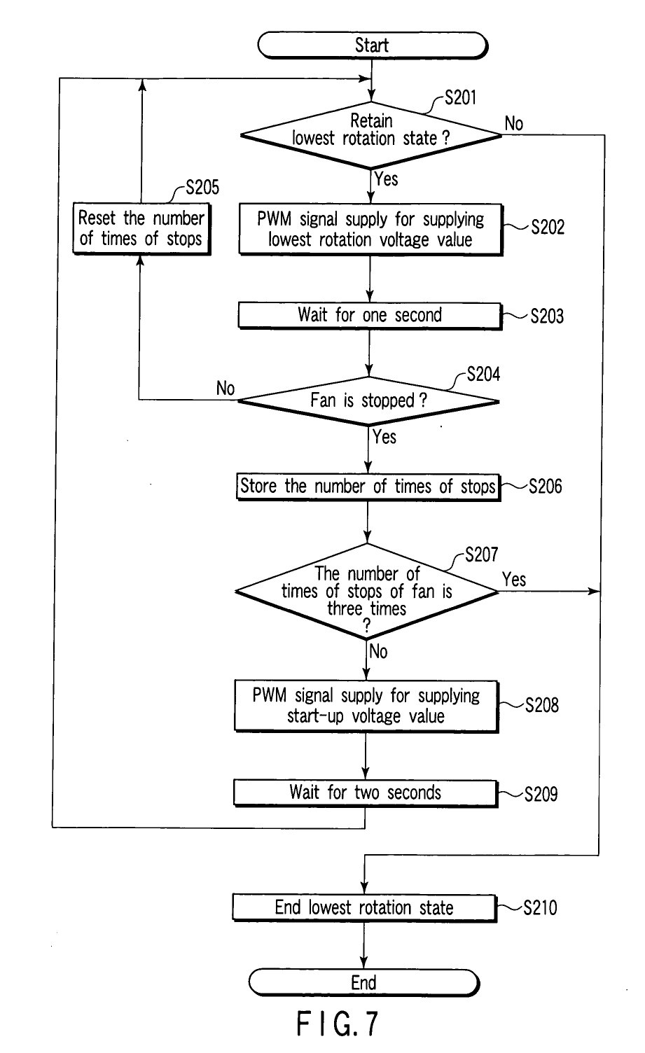

Now, there is a case where the fan 153 stops rotating, because the lowest rotation voltage is varied caused by temporal disturbance after the cooling fan 150 is driven with the lowest rotation voltage. Hereinafter, there is described about processing for monitoring rotation of the fan 153 driven with the lowest rotation voltage with reference to FIG. 7.

The EC/KBC 124 judges whether or not the lowest rotation state is retained (block S201). There is a case where the idling state of the semiconductor chip is released due to interruption, and further the lowest rotation state is released.

When the processing is not in the lowest rotation operation retaining state (No in block S201), the EC/KBC 124 ends the lowest rotation state (block S210).

When the lowest rotation state is retained (Yes in block S201), the EC/KBC 124 writes the lowest rotation voltage value stored in the lowest rotation voltage value register 170C in the drive voltage value register 170B, and the PWM circuit 170A supplies the PWM signal corresponding to the drive voltage value (lowest rotation voltage value) to the power supply controller 130 (block S202). The power supply controller 130 supplies the lowest rotation voltage value in accordance with the PWM signal to the cooling fan 150.

After waiting for one second (block S203), the EC/KBC 124 judges whether or not the fan stops (block S204).

When the fan 153 is not stopped (No in block S204), the EC/KBC 124 sets the number of times of stops to 0 by resetting writing of a number of times of stops register 170D for storing the number of times of stops of the fan 153 (block S205), before returning to the block S201.

When the fan 153 is stopped (Yes in block S204), the EC/KBC 124 adds one to the number of times of stops register 170D in order to store the number of times of stops of the fan 153 (block S206).

It is judged whether fan stopping occurs three times while counting the number of times of stops of the fan upon referring to the number of times of stops register 170D (block S207).

When the continuous number of times of stops of the fan is less than three times (No in block S207), the EC/KBC 124 writes the start-up voltage value in the drive voltage value register 170B, and the PWM circuit 170A supplies the PWM signal corresponding to the start-up voltage value to the cooling fan 150 (block S208). The power supply controller 130 supplies the start-up voltage as the drive voltage in accordance with the PWM signal to the cooling fan 150. The fan 153 rotates after the start-up voltage is supplied to the cooling fan 150. After waiting for two seconds (block S209), the processing is returned to the block S201.

In the case where the number of times of stops of the fan 153 is three times (Yes in block S207), the EC/KBC 124 ends the lowest rotation state (block S210).

By the processing described above, it is possible to monitor existence of rotation of the fan 153. After ending the lowest rotation state of block S210, it is preferable to control the number of rotations of the fan 153 depending on the temperature of the semiconductor device 140, or, as described using FIG. 6, it is preferable to obtain new lowest rotation voltage value.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a cooling fan which rotates from a stopping state upon supplying a voltage not less than a predetermined voltage value;
a first detection section which outputs a signal indicating whether the fan is rotating or not;
a storage section which stores voltage specification information indicating a voltage value supplied to the cooling fan;
a power supply which supplies a voltage corresponding to the voltage specification information stored in the storage section to the cooling fan;
a second detection section which detects a lowest rotation voltage value with which the cooling fan rotates, by setting the voltage specification information corresponding to the voltage value obtained by dropping voltage value by a predetermined step voltage value each from the predetermined voltage value, to the storage section while monitoring signals supplied from the first detection section; and
a setting section which sets the voltage specification information corresponding to the lowest rotation voltage value detected by the second detection section to the storage section.

2. The information processing apparatus according to claim 1, wherein the second detection section sets the voltage specification information, to the storage section, in accordance with the voltage value with which the cooling fan is capable of rotating from a state that the cooling fan is stopped, before setting the voltage specification information in accordance with the lowest rotation voltage value to the storage section.

3. The information processing apparatus according to claim 1, further comprising a processor,
wherein the cooling fan is mounted on the processor.

4. The information processing apparatus according to claim 1, further comprising a graphics controller which generates signals displayed on a display,
wherein the cooling fan is mounted on the graphics controller.

5. The information processing apparatus according to claim 1, further comprising an image quality adjustment processor to realize high image quality of a video displayed on the display,
wherein the cooling fan is mounted on the image quality adjustment processor.

6. The information processing apparatus according to claim 1, further comprising a TV tuner,
wherein the cooling fan is mounted on the TV tuner.

7. A fan control method comprising:
supplying a predetermined voltage value with which the fan is capable of rotating, to a cooling fan;
detecting a lowest rotation voltage value of rotating the cooling fan, by monitoring existence of the rotation of the cooling fan while dropping a voltage value supplied to the cooling fan by a predetermined step voltage value each from the predetermined voltage value; and
supplying the lowest rotation voltage value to the cooling fan.

8. The fan control method according to claim 7, further comprising:
supplying, to the cooling fan, a voltage value with which the cooling fan is capable of rotating from a state in which the cooling fan is stopped, before supplying the lowest rotation voltage value to the cooling fan.

9. The fan control method according to claim 7, wherein the predetermined voltage value capable of rotating the fan is a lower limit value of an operation guarantee voltage range of the cooling fan.

10. The fan control method according to claim 7, wherein existence of the rotation of the cooling fan is monitored after a predetermined time elapses, after dropping the voltage value supplied to the cooling fan by a predetermined step.
